(19) United States
(12) Patent Application Publication
(10) Pub. No.: US 2006/0074800 A1
(43) Pub. Date: Apr. 6, 2006

(54) Conscription income protection plan and military draft insurance

(76) Inventor: Ralph Mitchell, Weymouth, MA (US)

Correspondence Address: Carthage Financial Group;Attn: Ralph Mitchell, Suite #200, 140 Wood Road, Braintree, MA, 02184, US

(21) Appl. No.: 11/013,658

(22) Filed: Dec. 17, 2004

Related U.S. Application Data
(60) Provisional application No. 60/613,913, filed on Sep. 28, 2004.

(51) Int. Cl. G06Q 40/00

(52) U.S. Cl. 705/40

(57) ABSTRACT

A method of insuring military draftees for the reduction of income due to involuntary active military duty includes collecting payments on behalf of a draftee, amounts of the payments being based upon civilian income of the draftee and desired compensatory income during times of active military duty, and providing the desired compensatory income for the draftee during at least a portion of a first time period of active military duty of the draftee in response to receiving a request for compensatory income on behalf of the draftee.

### CROSS-REFERENCE TO RELATED ACTIONS

This application claims the benefit of U.S. Provisional Application No. 60/613,913 filed on Sep. 29, 2004.

### FIELD OF THE INVENTION

The invention relates to insurance policies, especially for U.S. citizens eligible to be involuntarily drafted for military service.

### BACKGROUND OF THE INVENTION

The current state of world affairs places an enormous responsibility upon the United States as the last remaining “Super Power” when it comes to maintaining regional stability on a global perspective. The US Department of Defense is charged with using military power to enforce the political objectives and foreign policies as dictated by the office of the President of the United States. With no opposing foreign military powers that have massive deployment capabilities as a clearly defined and immediate threat, Congress dating back to the 1990s has repeatedly sought to reduce the appropriated funding for defense. The Soviet Union had been our biggest adversary during the Cold War until their system finally collapsed and they stopped being a major threat. The First Gulf War that took place in 1991 capitalized on the utilization of advanced technology and weaponry and major combat operations on the ground ended within a few months. At the end of that war, nobody ever envisioned military commitments that would ever again involve ground warfare with massive numbers of US troops deployed over an extended number of years. Unfortunately the political concepts of Peace-keeping missions, Humanitarian Relief, the expanding War on Terrorism in Afghanistan and the Iraqi War have sent more US ground troops on deployments on foreign soil that ever before. Yet the current-troop strengths of today's armed forces are only a fraction of what existed during the height of the Cold War. The result of years of previous cuts in defense spending coupled with increased numbers of deployments has led to increased reliance upon guard and reserve personnel from within each branch of our armed services as fully integrated members of the total fighting force. Even with the mobilization of these personnel, there still are not enough people willing to serve in uniform to accomplish everything that must be done.

The risks of mortal danger combined with very meager paychecks from military service have caused many in uniform to rethink their career options. Civilian jobs that offer no physical danger, more personal freedoms and more lucrative monetary compensation will indeed look more attractive. As a result of the prolonged deployments into unsavory regions such as Bosnia, Croatia, Afghanistan and Iraq, the numbers of personnel deciding to stay and re-enlist in the military and those of new recruits signing up are at the lowest levels in many decades. Many men and women in uniform cringe at the very thought of serving multiple tours in hostile areas. The Defense Department has even offered unprecedented financial incentives as inducements for them to remain on deployment, and is still failing to maintain the desired troop strength that the higher commands feel is warranted.

Once the troops return stateside, many of them are mustering out of the service either by refusing to re-enlist once their contract expires, retiring from military service just as soon as eligible to guarantee receipt of their monthly pension money, or in some cases simply running away and going AWOL (absent without leave). At this time, there is not even enough money in the domestic military budget to even try and recapture AWOL soldiers. Therefore, there is little to stop them from running. Several military units have returned from overseas deployments with a strength level of at least 90%. But in the wake of being stateside for a few months, their overall force will dissipate to a level of approximately one third still remaining.

The prolonged War on Terrorism and the war in Iraq have practically brought our armed services (especially the Army) to the breaking point. There simply are just not enough trained personnel willing to serve in uniform to accomplish all of the military's missions. Looking back at history, Congress at times has authorized involuntary conscription to fill the ranks with adequate numbers of personnel. Back then, there were numerous cases where individuals whom had been highly paid entertainers, professional athletes, entrepreneurs and other assorted celebrities had to forego their lavish earnings for a number of years and accept a drastically meager paycheck from military service. Had such a program of income protection during involuntary military service existed back in the 1940s through the 1960s, certain individuals could have saved millions of dollars in lost personal revenue which led to financial hardships.

### SUMMARY OF THE INVENTION

In general, in an aspect, the invention provides a method of insuring citizens eligible for a military draft from a reduction in personal earnings due to involuntary military duty; the method including collecting payments on behalf on the potential draftee, amounts of the payments being based upon verified civilian income of the draftee and desired compensatory income for the draftee during times of involuntary military service, and providing the desired compensatory income for the draftee during at least a portion of a first time period of active military duty of the draftee in response to receiving a request for compensatory income on behalf of the draftee.

Implementation of the invention may include one or more of the following features. The payment amounts are further based on at least one personal factor associated with the draftee. The at least one personal factor is at least one of an age of the draftee, length of occupation of the draftee in the draftee's current civilian occupation, formal academic background of the draftee, marital status of the draftee, number of household dependents of the draftee, expected military pay grade of the draftee, number of years of prior military experience if any, number of years of civilian employment, current civilian employment contracts, expected level of military responsibility, and level of civilian-employment responsibility. Providing the compensatory income is inhibited until at least one of a first threshold cumulative total of payments is collected, a second threshold of number of payments is collected, and a third threshold of a designated time period during which payments have been collected elapses. The at least a portion of the compensatory income is provided during a second time period after the first time period, wherein the draftee is off active military duty during the second time period. The compensatory income includes a desired replacement income for paying a person to replace the draftee at the draftee's civilian occupation while the draftee is away on active military duty, and wherein the payment amounts further depend upon the desired replacement income.

In general, in another aspect, the invention provides an insurance policy for draftees for compensating for reduction of income due to active military duty, the insurance policy including provisions for collecting payments, amounts of the payments being based upon civilian income of a draftee and desired compensatory income for the draftee during at least times of active military duty of the draftee, receiving a request for compensatory income, and providing the desired compensatory income during at least a portion of a time period of active military duty of the draftee.

Implementations of the invention may include one or more of the following features. The payment amounts are further based on at least one personal factor associated with the draftee. The at least one personal factor is at least one of an age of the draftee, length of occupation of the draftee's current civilian occupation, formal academic background of the draftee, marital status of the draftee, number of household dependents of the draftee, military pay grade of the draftee, number of years of military experience if any, level of military responsibility, number of years of civilian employment, current civilian employment contracts and level of civilian-employment responsibility. The policy further includes a provision to inhibit the compensatory income from being provided until at least one of a first threshold cumulative total of payments is collected, a second threshold of number of payments is collected, and a third threshold of a designated time period during which payments have been collected elapses. The provision to inhibit the compensatory income from being paid allows a portion, less than the full amount, of the compensatory income to be paid before at least one of the first threshold cumulative total of payments is collected, the second threshold of number of payments is collected, and the third threshold of the designated time period during which payments have been collected elapses. The policy further includes a return of premium provision for returning a portion of the payments collected if at least one return condition is satisfied, the payment amounts further depending upon election of a return of premium option. The return condition is at least one of that no requests for compensatory income are received, and that compensatory income provided under the plan is below a threshold level relative to a sum of payments collected under the insurance plan.

In general, in another aspect, the invention provides an insurance policy for draftees for compensating for reduction of income due to active military duty, the insurance policy including provisions for collecting payments, amounts of the payments being based upon desired compensatory income for a draftee during at least times of active military duty of the draftee, providing the desired compensatory income during at least a portion of a first time period of active military duty of the draftee, and providing at least a portion of the compensatory income during a second time period after the first time period, wherein the draftee is off active military duty during the second time period.

Implementations of the invention may have amounts of the payments being also based upon civilian income of the draftee.

In general, in another aspect, the invention provides an insurance policy for draftees for compensating for reduction of income due to active military duty, the insurance policy including provisions for collecting payments, amounts of the payments being based upon desired compensatory income for a draftee during at least times of active military duty of the draftee, and providing the desired compensatory income during at least a portion of a time period of active military duty of the draftee, where the compensatory income includes a desired replacement income for paying a person to replace the draftee while the draftee is on active military duty, and where the payment amounts depend upon the desired replacement income.

Implementations of the invention may have amounts of the payments being also based upon civilian income of the draftee.

In general, in another aspect, the invention provides for an insurance policy for draftees for compensating for business impact of the personnel's absence due to active military duty, the insurance policy including provisions for collecting payments, amounts of the payments being based upon desired compensatory income that is based on expected financial impact on a business of a draftee's absence during at least times of active military duty of the draftee, and providing the desired compensatory income during at least a portion of a time period of active military duty of the draftee.

Implementations of the invention may include one of more of the following features. The amounts of payments are based on at least one of a number of draft eligible personnel in the business and the likelihood of said personnel being involuntarily drafted for active military duty. The desired compensation is at least partially dependent on at least one of a number of persons drafted, length of expected mobilization(s), and estimated cost due to the mobilization(s) based on prior profitability of the business.

Various aspects of the invention may provide one or more of the following capabilities. A financially-sound insurance system for providing military draftees with supplemental income to compensate for active military duty may be provided. Eligible draftees can guard against financial hardship brought on by calls to active military service. Insurance can be provided for military draftees without requiring outside funding, thus providing a self-sufficient insurance system.

These and other capabilities of the invention, along with the invention itself will, be more fully understood after a review of the following figures, detailed description, and claims.

### BRIEF DESCRIPTION OF THE FIGURES

FIG. 1 is a block diagram of an exemplary insurance policy according to the invention.

FIG. 2 is a block flow diagram of a process of issuing and implementing the insurance policy shown in FIG. 1.

FIG. 3 is a block flow diagram of a process of providing disbursements according the insurance policy shown in FIG. 1.

### DETAILED DESCRIPTION OF PREFERRED EMBODIMENTS

Embodiments of the invention provide insurance for military draftees to provide supplemental income due to active military service. An eligible draftee may obtain a Conscription Income Protection Program (CIPP) insurance policy. The eligible draftee of his/her designee makes payments according to the policy. The amounts of the payments are preferably related to the maximum amount of disbursements that the eligible draftee could seek under the policy if called to active duty, and related to the draftee's civilian income. If the draftee is called to active duty, then the draftee can request compensatory, supplemental income be disbursed to the draftee according to the policy. If a build-up period has passed since the draftee began making payments to the policy, and an elimination period has passed since the draftee is called to active duty, then disbursements can be made to the draftee for a benefit period of time up to a maximum benefit level. The draftee may be able to receive compensatory income under the policy after the call to active duty ends. A third party, such as a company or individual, may be paid some or all of the compensatory income if the draftee has elected a “key man insurance” option under the policy. Also, if less than a threshold amount of claims are made against the policy and/or less than a threshold cumulative amount of compensatory income is paid under the policy, a portion of the payments made to the policy may be returned if the draftee elected a “return of premium” option in the policy. Other embodiments are within the scope of the invention.

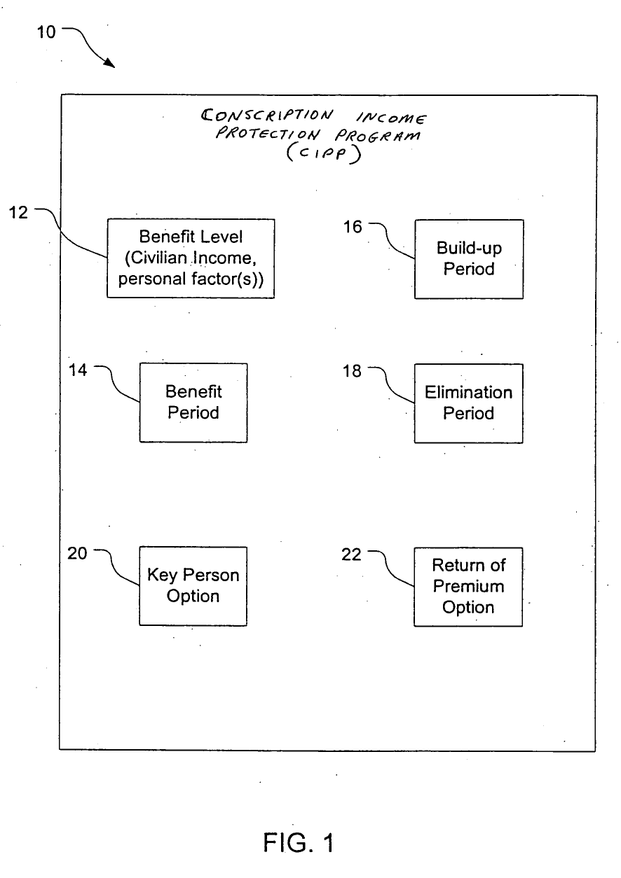

Referring to FIG. 1, a CIPP insurance policy 10 available from an insurer for military draftees includes provisions for benefit level 12, benefit period 14, build-up period 16, elimination period 18, key man 20, and return of premium 22. The insurance provided by the policy 10 treats involuntary active military duty like a disability to the draftee. Some of the provisions in the policy 10 are configurable, may vary from draftee to draftee, and may be elected or not be elected. The policy 10 as a whole is designed such that draftee's incomes can be protected through an economically viable, preferably self-supporting program.

The benefit level provision 12 defines the amount of compensatory income to be received by a draftee that qualifies for disbursements. The amount of compensatory income to be received may be elected by the draftee. The benefit level is the periodic, e.g., monthly, amount to be received by the draftee. The benefit level amount may be limited based upon the draftee's civilian and military incomes, in particular the excess of civilian income over military income. If the draftee's military income exceeds the draftee's civilian income, then the policy 10 may not be available to the draftee. Thus, the draftee's civilian income is preferably verified, e.g., based on previous earnings, e.g., indicated by federal tax returns, W2s and/or 1099s. The benefit level may also be limited, e.g., with a maximum amount available per pay period or other unit of time. This maximum amount may be the same for different draftees, or may vary between draftees depending on one or more factors such as the draftee's customary civilian income, the draftee's likelihood of call-up to active duty (e.g., based on age, gender, student status, marital status, numbers of household dependents, customary civilian occupation, primary residence, etc.), the likely length of any such call-up, etc. Other factors could include an individual's physical health, potential military job description and perceived shortages within the active duty forces of skilled personnel for such tasks. The benefit level may be a constant level, or may vary between draftees, e.g., depending upon customary civilian pay, as long as the benefit level does not exceed the designated maximum.

The benefit level provision 12 further defines the amount of premium payments to be made by the draftee. The payment amounts depend upon one or more occupational demographics of the draftee and/or one or more personal factors of the draftee. For example, preferably the payment amount owed by the draftee depends upon the amount of compensatory income to be paid, and the draftee's civilian income level. All other things being equal, draftees with higher civilian incomes will need to pay more for a larger prospective benefit level. Further, the amount owed by a draftee may depend upon at least one of an age of the draftee, length of occupation of the draftee in the draftee's current civilian occupation, formal academic background of the draftee, marital status of the draftee, number of household dependents of the draftee, expected military pay grade of the draftee, number of years of prior military experience if any, number of years of civilian employment, current civilian employment contracts, expected level of military responsibility, and level of civilian-employment responsibility. Essentially, as the likelihood of call-up and/or the likely length of any call-up increases, so does the payment that the draftee will need to make.

The benefit period provision 14 defines the duration of disbursements from the insurer to the draftee. This duration may be an amount of time during which the draftee may receive disbursements under the policy 10. For example, the benefit period is preferably a short-term policy that will pay the draftee up to, e.g., one year, two years, three years, four years, etc. Alternatively, the benefit period may be defined in terms of total amount of compensatory disbursements provided. For example, if the benefit level is allowed to vary, then the benefit period may be a total cumulative disbursement amount, that if reached, will terminate the disbursements. Different cumulative amounts may be specified for a single military deployment and multiple deployments (e.g., different amounts up to a predetermined number of deployments, after which the cumulative amount does not vary). Historically, draftees have been called-up for two years, although longer tours of duty are not outside the realm of possibility.

As part of the benefit provision 14, or possibly as a separate option, the policy 10 may specifically provide for the draftee to receive compensatory income after an involuntary active duty call-up ends. This post-duty benefit period can help the draftee that returns to civilian life to find that his/her civilian job is gone, or whose job is lost soon after return to civilian life. The draftee may be left without a job, or with a job that has a lower income than the former job the draftee had at the time prior to military call-up. The benefit period may thus include time for the returning draftee to find new employment or to otherwise get re-established in a professional capacity. As no additional military pay will be received upon release from active duty, the policy 10 may compensate for this loss combined with a reduction in civilian income compared to when the draftee was called to duty. Preferably, the time period for this post-duty benefit is one year. This may be included as part of the base benefit period such that the benefit period is, e.g. three years to allow disbursements to the draftee as long as the draftee is on active duty, and has returned to civilian life but whose civilian income has declined since being called up. Payments made to the draftee after being relieved from active military duty may be in amounts that are lower than amounts paid to the draftee during active military duty.

The build-up period provision 16 defines the duration of payments to the insurer by the draftee before disbursements will be made by the insurer to the draftee. The build-up period is designed to help ensure that the CIPP is economically viable, especially if the draftee falls within a demographic class where claims are likely to be submitted before the policy has accumulated sufficient capital to be economically viable otherwise. This duration may be an amount of time before which the draftee may not receive disbursements under policy 10. For example, the build-up period may be months or even years. Alternatively, the build-up period may be defined in terms of total amounts of payments made. For example, some draftees may already be expected to be called forth within the near future. A one-year period may be required for any draftee signing up for the policy 10, and this period may be even longer for draftees who have already received notification and awaiting their reporting date.

The elimination period provision 18 dictates a duration after an insured event, e.g., call-up to active military duty, that must pass before disbursements will be made to the draftee. This duration may be an amount of time before which the draftee may not receive disbursements under policy 10. For example, the elimination period may be days, weeks, or months. Alternatively, the elimination period may be defined in terms of total amount of payments made after the insured event. The elimination period eliminates short-term call-ups from triggering payments, as the draftee is not expected to be dramatically financially affected by short-term call-ups of only a few days, and helps to ensure the financial viability of the CIPP. Since draftees are often sent forth on short-term call-ups to attend briefings, take physical exams and etc., the elimination period could be set, e.g., at 30 days, to exclude from disbursements initial in-processing that may only determine that they are not even suitable for military service.

The key person provision 20 is designed to provide special assistance to businesses where a draftee is key to the operations of that enterprise, e.g., a key member of company management, the most valued player on an athletic team, the lead actor in a stage production, or a sole proprietor. Key person insurance thus provides not only compensatory income for the draftee, but also provides funds to the business to hire a qualified replacement during the draftee's absence (e.g., a person who has retired, yet is still qualified to perform that draftee's job). This provision may result in substantial outlays of monies, as the disbursements may be nearly double the draftee's pay (i.e., the pay for the replacement employee plus the difference between the draftee's civilian income and the draftee's military income). The key person provision 20, the policy 10 (or a separate policy) may provide for compensation to a business due to one or more draftee's being called away for duty; even if the draftee(s) is (are) not considered of fundamental importance to the business. This insurance may be modified to assess the effect of the loss of the draftee on the business and to provide for compensation for this loss if the draftee is called to active duty. Costs can be incurred by employers due to lost productive time. Personnel absent due to the draft or mobilizations of guard and reserve personnel may induce one or more of a variety of consequences affecting profitability of a business. For example, other employees may be forced to work extra, including overtime, recruiting new employees may be undertaken (including Human Resources time and other employee time, including management, to interview potential candidates), etc. Replacement employees will likely be less productive initially than the employees they replace. Replacement employees may need to undergo training before they can become productive. Thus, the provision 20 may provide for paying money to compensate for this lost productivity. The amount of payments made to secure this provision may be based on the numbers of potential draftees, numbers of guard and reservists, likelihood of call-up, etc. The amount paid may be a fixed amount (e.g., per employee called up), partially variable, or all variable. Variable compensation may depend on, e.g., numbers of persons called-up, length of expected duration(s), cost estimates based upon prior profitability, etc. The provision 20 may be applied as a Rider or as an Option. This provision may be similar to Overhead Insurance or Business Income Coverage that is typically designed to protect businesses against loss of revenue due to damage to property such as equipment or a building. This insurance may be obtained by the draftee, or possibly by the business itself.

The return of premium provision 22 provides for the return of a portion of the payments made by the draftee if the draftee has not received significant disbursements from the CIPP under policy 10. For example, if no claims are ever made for disbursements, of if fewer than a threshold number of claims are made, or if less than a threshold amount of money is disbursed under the policy 10, then the draftee may be entitled to receive a return of some of the money paid into the CIPP. The amount returned to the draftee may depend upon various factors such as an amount (e.g., percentage of payments, or absolute dollar amount) desired to be returned, the number of claims made, the amount of total disbursements made under the policy 10 and/or the amount of payments made under policy 10, etc. Opting for the return of premium provision 22 will increase the amount that the draftee will pay into the program. As with other provisions of the policy 10, the return of premium provision 22 may not be provided at all, and/or may not be elected by the draftee.

There may be various tax consequences associated with participation in the CIPP. Whether premiums paid are tax deductible by the draftee and whether the insurance benefits received are taxable depends on what category of money was used to make the payments. Pre-tax dollars can be used to purchase insurance products, e.g., taken directly from an insured person's paycheck before payroll taxes are assessed. Insurance policies, including disability insurance, purchased with pre-tax dollars often produce a taxable event if/when benefit money is received by the insured. If premiums on the policy 10 are paid with dollars that have already been taxed, then the benefit money disbursed will likely be tax-free.

Preferably, the payments under the policy 10 will be made using pre-tax dollars as the CIPP intends to ensure financial stability for military draftees that have been involuntarily called forth. Using pre-tax dollars would lower the amount of payroll tax assessments. The disbursements made under policy 10 would then be taxable income. The amount of taxation, however, would likely be no different than what the draftee had been paying due the draftee's overall gross income being essentially the same, assuming the benefit level approximates the gap or difference between the draftee's civilian income rate and the draftee's military income rate.

The CIPP may be reinsured, that is, the policies 10 that are issued to draftees may themselves be insured by the primary insurer through a secondary insurer. The primary insurer may take out an insurance policy with another secondary insurer to guard against financial ruin of the company should a large number of claims be made under the policies 10 to the primary insurer producing an exceptional volume of disbursements. Indeed, the secondary insurer may also take out reinsurance policies, known as retrocessions.

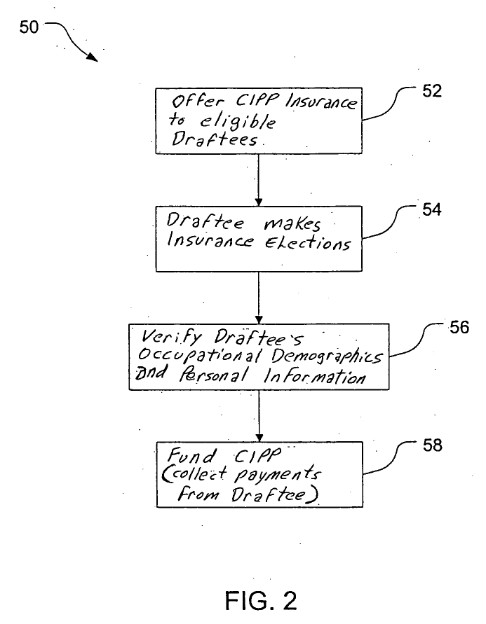

In operation, referring to FIG. 2, with further reference to FIG. 1, a process 50 for issuing and implementing the insurance policy 10 includes the stages shown. The process 50, however, is exemplary only and not limiting. The process 50 may be altered, e.g., by having stages added, removed, or rearranged.

At stage 52, the policy is offered to the draftee. The CIPP is made known to draftees through appropriate media channels. The CIPP may be provided by a private insurance carrier, e.g., in cooperation with the Defense Department or other portion of the government.

At stage 54, the draftee signs up for benefits under the policy 10. The draftee selects which options the draftee wants, e.g., the return of premium provision 22. The draftee also selects appropriate values associated with the provisions of the policy 10, e.g., the benefit level, the frequency of distributions, the amount of premium reimbursement, a desired benefit period, etc. At this time, the draftee also provides occupational demographic information (e.g., civilian job description, civilian income, etc.) and personal information (e.g., age, academic background, marital status, number of household dependents, etc.)

At stage 56, the information provided by the draftee is verified. For example, the draftee's tax returns, W2s, 1099s. etc may be analyzed, as well as other checks to confirm the veracity of the information provided by the draftee, particularly any information that will affect the draftee's status as a key person and the income needed to hire a suitable/qualified replacement in the draftee's absence.

At stage 57, the CIPP is funded. For example, premium payments are collected from the draftees/applicants participating in the CIPP. The payments are stored, and preferably invested, for use in providing disbursements of compensatory income to qualifying draftees. Funds may also, or alternatively, be gathered from other governments, in particular the militaries of other countries, by an insurance manager in a slush fund. The slush fund would be the repository for funds to be disbursed to qualifying draftees from any of the countries contributing to the slush fund.

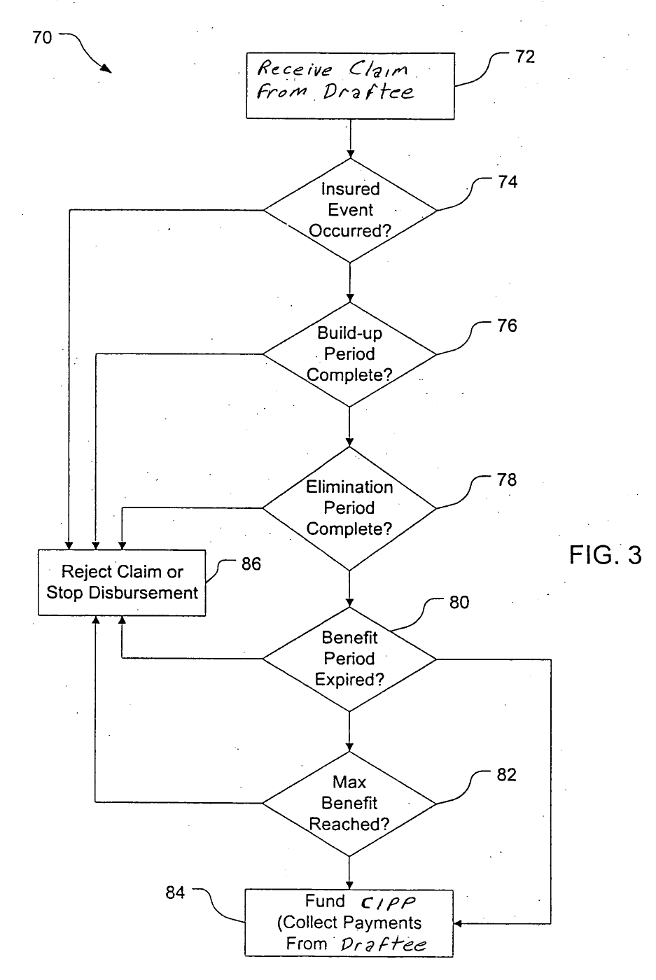

In operation, referring to FIG. 3, with further reference to FIGS. 1-2, a process 70 of providing disbursements according the insurance policy 10 includes the stages shown. The process 70, however, is exemplary only and not limiting. The process 70 may be altered, e.g., by having stages added, removed, or rearranged.

At stage 72, the draftee makes a claim against the policy 10. The draftee fills out the appropriate paperwork requesting that compensatory income disbursements be made, e.g., to the draftee, a person or other entity designated in the policy 10 by the draftee, or to a person or other entity designated in the claim. A claim may also be automatically initiated by the military when the draftee is called to or reports for active duty. The claim is evaluated to determine whether payments are warranted, and if so, in what amount.

At stage 74, an inquiry is made as to whether an insured event has occurred. Here, it is determined whether the draftee has been called to involuntary active duty, or if reporting for voluntary active duty, whether that qualifies under the policy 10 as an insured event. If an insured event has not occurred, then the process 70 proceeds to stage 86, described below. If an insured event has occurred, then the process proceeds to stage 76.

At stage 76, an inquiry is made as to whether the build-up period is complete. Here, it is determined whether the draftee has been making payments for sufficient time, or possibly whether the draftee has made adequate total payments. If the build-up period is not complete, then the process 70 proceeds to stage 78.

At stage 78, an inquiry is made as to whether the elimination period is complete. Here it is determined whether sufficient time has passed since the occurrence of the insured event (or other criteria met). If the elimination period is not complete, then the process 70 proceeds to stage 86, described below. If the elimination period is complete, then the process 70 proceeds to stage 80.

At stage 80, an inquiry is made as to whether the benefit period is complete. Here, it is determined whether the draftee has been receiving disbursement for the allowed time. This benefit period may include time after the draftee is relieved from active military duty, e.g., if the draftee verifies that the active military duty resulted in a decrease (including elimination) of the draftee's civilian pay. If the benefit period is complete, then the process 70 proceeds to stage 86, described below. If the benefit period is not complete, then the process 70 proceeds to stage 82.

At stage 82, an inquiry is made as to whether the maximum amount of disbursements has been reached. Here, it is determined whether the draftee has been paid a predetermined maximum amount (e.g., for this particular deployment, or for a single deployment or multiple deployments, the amounts for which possibly being different) has been reached, then the process 70 proceeds to stage 86, described below. If the maximum benefit amount has not been reached; then the process 70 proceeds to stage 84.

At stage 84, the insurer disburses compensatory money on behalf of the draftee. The compensatory income may be disbursed to the draftee, or to an entity designated by the draftee (e.g., spouse). For Key Person insurance, Overhead Insurance, or Business Income Coverage, disbursements are preferably made to the appropriate business or other designee of the draftee. The process 70 returns to stage 80 to determine if further disbursements are warranted.

At stage 86, the draftee's claim is rejected, or further payments are terminated. If the draftee's claim is unjustified, e.g., because the build-up period or elimination period is incomplete, or an insured event has yet to occur (or recur); then the draftee's claim is rejected and the draftee appropriately informed. If the draftee's claim has been granted/approved, but disbursements are not longer warranted, e.g., because the benefit period has expired, or the maximum allowable amount of payments to or on behalf of the draftee has been made, then the disbursements are terminated and the appropriate party(ies), e.g., the draftee, the draftee's business, and/or the draftee's designee(s), are appropriately informed of the cessation of payments.

Other embodiments are within the scope and spirit of the appended claims. For example, several governments could pool resources to produce a slush find for insuring each other's military draftees in case of military call-ups. The money put into the slush fund may or may not be obtained, or may be partially obtained, from the draftees themselves through payments into insurance policies. Such a slush fund may be managed by an insurance provider, but funded by various governments, e.g. a bloc of allies. Further, some amount of money may be paid before a build-up period has expired. For example, a portion of the benefit amount may be paid before the build-up period is reached. The portion paid may vary, increasing as the end of the build-up period approaches. The amount paid may not reach the full benefit amount until after the build-up period has been reached to help compensate for money being paid in advance of the build-up period being reached.

What is claimed is:

1. A method of insuring military draftees against reduction in personal earnings due to military duty, the method comprising:
collecting payments on behalf of a draftee, amounts of the payments being based upon civilian income of the draftee and desired compensatory income during times of active military duty; and
providing the desired compensatory income for the draftee during at least a portion of a first time period of active military duty of the draftee in response to receiving a request for compensatory income on behalf of the draftee.

2. The method of claim 1 wherein the payment amounts are further based on at least one personal factor associated with the draftee.

3. The method of claim 2 wherein the at least one personal factor is at least one of an age of the draftee, formal academic background of the draftee, marital status, numbers of household dependents claimed by the draftee, number of years of civilian employment, civilian employment contracts, and level of civilian-employment responsibility.

4. The method of claim 1 wherein providing the compensatory income is inhibited until at least one of a threshold cumulative total of payments is collected, a second threshold of number of payments is collected, and a third threshold of a designated time period during which payments have been collected elapses.

5. The method of claim 1 wherein at least a portion of the compensatory income is provided during a second time period after the first time period, wherein the draftee is off active military duty during the second time period.

6. The method of claim 1 wherein the compensatory income includes a desired replacement income for paying a person to replace the draftee at the draftee's civilian occupation while the draftee is away on active military duty, and wherein the payment amounts further depend upon the desired replacement income.

7. An insurance policy for military draftees for compensating for reduction in income due to active military duty, the insurance policy comprising provisions for:
collecting payments, amounts of the payments being based upon civilian income of a draftee and desired compensatory income for the draftee during at least times of active military duty of the draftee;
receiving a request for compensatory income; and
providing the desired compensatory income during at least a portion of a time period of active military duty of the draftee.

8. The policy of claim 7 wherein the payment amounts are further based on at least one personal factor associated with the draftee.

9. The policy of claim 8 wherein the at least one personal factor is at least one of an age of the draftee, length of occupation of the draftee in his/her current civilian occupation, formal academic background of the draftee, marital status of the draftee, number of household dependents of the draftee, military pay grade of the draftee, number of years of civilian employment, and level of civilian-employment responsibility.

10. The policy of claim 7 further comprising a provision to inhibit the compensatory income from being provided until at least one of a first threshold cumulative total payments is collected, a second threshold of number of payments is collected, and a third threshold of a designated time period during which payments have been collected elapses.

11. The policy of claim 10 wherein the provision to inhibit the compensatory income from being paid allows a portion, less than a full amount, of the compensatory income to be paid before at least one of the first threshold cumulative total of payments is collected, the second threshold of number of payments is collected, and the third threshold of the designated time period during which payments have been collected elapses.

12. The policy of claim 7 further comprising a return of premium provision for returning a portion of the payments collected if at least one return condition is satisfied, the payment amounts further depending upon election of a return of premium option.

13. The policy of claim 12 wherein the return condition is at least one that no requests for compensatory income are received, and that compensatory income provided under the plan is below a threshold level relative to a sum of payments collected under the insurance plan.

14. An insurance policy for military draftees for compensating for reduction of income due to involuntary active military duty, the insurance policy comprising provisions for:
collecting payments, amounts of the payments being based upon desired compensatory income for a draftee during at least times of active military duty of the draftee;
Providing the desired compensatory income during at least a portion of a first time period of active military duty of the draftee; and
Providing at least a portion of the compensatory income during a second time period after the first time period, wherein the draftee is off active military duty during the second time period.

15. The policy of claim 14 wherein the amounts of the payments are also based upon civilian income of the draftee.

16. An insurance policy for military draftees for compensating for reduction of income due to involuntary active military duty, the insurance policy comprising provisions for:
collecting payments, amounts of the payments being based upon desired compensatory income for a draftee during at least times of active military duty of the draftee; and
wherein the compensatory income includes a desired replacement income for paying a person to replace the draftee while the draftee is on active military duty; and
wherein the payment amounts depend upon the desired replacement income.

17. The policy of claim 16 wherein the amounts of the payments are also based upon civilian income of the draftee.

18. An insurance policy for military draftees for compensating for business impact of the personnel's absence due to active military duty, the insurance policy comprising provisions for:
collecting payments, amounts of the payments being based upon desired compensatory income that is based on expected financial impact on a business of a draftee's absence during at least time of active military duty of the draftee; and
providing the desired compensatory income during at least a portion of a time period of active military duty of the draftee.

19. The policy of claim 18 wherein the amounts of payments are based on at least one of a number of draftees employed in the business and the likelihood of said draftee(s) being called to serve on active military duty.

20. The policy of claim 18 wherein the desired compensation is at least partially dependent on at least one of a number of persons mobilized, length of expected mobilization(s), and estimated cost due to the mobilization(s) based upon prior profitability of the business.
